(19) United States
(12) Patent Application Publication
(10) Pub. No.: US 2006/0058142 A1
(43) Pub. Date: Mar. 16, 2006

(54) Endless belt for transmission

(75) Inventors: Masahiro Hasebe, Aichi-ken (JP); Kenichi Shimakawa, Aichi-ken (JP)

Correspondence Address: George A. Loud, Esquire;BACON & THOMAS, Fourth Floor, 625 Slaters Lane, Alexandria, VA, 22314-1176, US

(73) Assignee: KABUSHIKIKAISHA EQUOS RESEARCH, Tokyo (JP)

(21) Appl. No.: 11/153,887

(22) Filed: Jun. 16, 2005

(30) Foreign Application Priority Data
Jun. 23, 2004 (JP) 2004-184999

(51) Int. Cl. F16G 13/04; F16G 13/02

(52) U.S. Cl. 474/215; 474/214; 474/229

(57) ABSTRACT

An endless transmission belt is provided with a link plate, and a pair of joint pins that are retained by the link plate. Through the rolling of mutually contacting faces of the joint pins, link plates are mutually and rotatably connected into an endless chain. One joint pin of the pair is a pin with a large sectional area that transmits driving force from a pulley and the link plate, whereas the other joint pin of the pair is a pin with a small sectional area that transmits the driving force from the driving pin to the link plate. In order to reduce the concentration of stress on the side retaining the pin with a small sectional area, a peripheral width of the link plate on that side is made wider than the peripheral width on the side retaining the pin with a large sectional area.

### CROSS-REFERENCE TO RELATED APPLICATIONS

This application claims, under 35 USC 119, priority of Japanese Application No. 2004-184999 filed Jun. 23, 2004, the teachings of which are incorporated by reference herein in their entirety, inclusive of the specification, drawings and abstract.

### BACKGROUND OF THE INVENTION

1. Field of the Invention

The present invention relates to an endless belt for a belt-type continuously variable transmission. More particularly, the present invention relates to an endless transmission belt that is wound around two pulleys disposed on parallel axes, to transmit torque between the two pulleys, and is formed of a plurality of link plates connected into an endless chain by joint pins.

2. Description of the Related Art

A belt-type continuously variable transmission (CVT), in which an endless belt is wound between two pulleys disposed on parallel axes, is one type of continuously variable transmission. In a continuously variable transmission, a speed change (a change in a speed ratio between a primary pulley and a secondary pulley) is achieved as follows: the space between sheave faces at least one pulley (the primary pulley and/or the secondary pulley), on parallel rotational axes, is changed, so as to change the distance from the center of a rotational axis up to the position of the endless belt within the pulley groove (i.e., the turning radius of the endless belt on a pulley, namely, pitch radius). Thus, from the position where the endless belt rides on the pulley, torque is transmitted from the primary pulley to the endless belt on a driving side, whereas torque is transmitted from the endless belt to the secondary pulley on a driven side.

There are various types of endless belts used in belt-type continuously variable transmissions. One type has a plurality of link plates connected into an endless chain configuration by joint pins, and torque is transmitted in accordance with the position of engagement of the pulley wall faces with the opposing ends of the joint pins (see U.S. Pat. No. 5,427,583). In such an endless belt, as shown by the side view of a belt portion in FIG. 5, sets of joint pins a, b have adjacent opposing faces a₁, b₁. Each pin is retained so as not to slide relative to a link plate c at other locations a₂, b₂ on their peripheral faces. Accordingly, the set of pins a, b rolls relative to the link plate c at the abutting faces a₁, b₁, resulting in the rotation of the link plate c relative to each pin. Therefore, there is no friction at a joint (connection) formed by the set of pins, and moreover, the belt gains the benefit of little friction loss.

In such a belt, joint pins periodically clash with the pulley. At such times, noise and vertical vibrations in the linear run of the belt spanning the pulleys are known to occur during the period between the time when one pin contacts and engages the pulley up until the next pin contacts the pulley, while the pin already engaged with the pulley moves in accordance with the rotation of the pulley. This vertical vibration phenomenon is called the polygonal effect.

U.S. Pat. No. 5,728,021 discloses an endless belt in which such vibration and resultant noise are reduced by varying the lengths of a set of joint pins, such that only one pin in the set contacts the pulley. Although the design described in U.S. Pat. No. 5,728,021 excels at damping noise, the sectional areas of the set of pins may vary due to the different roles of each pin. In particular, strength is required for the pin that contacts the pulley and transmits torque to the pulley, while the pin that does not come in contact with the pulley does not require as much strength. Based upon such a relationship, it is possible to make the sectional area of the pin that does not contact the pulley smaller than that of the pin contacting the pulley. Decreasing the sectional area of one pin in this manner can result in a smaller gap (i.e., pitch interval) for the pin that contacts the pulley, which is effective for reducing the polygonal effect.

However, if one pin of the set is made smaller, this in turn makes the length of the peripheral face of the pin not contacting the pulley, shorter than that of the pin contacting the pulley. At the same time, the tensile force transmitted by the belt along its length acts at the point of contact between the pin and the link plate, and this stress is increased as the result of a shorter length of contact. That is, in the link plate the stress on the pin not contacting the pulley becomes greater than the stress in the vicinity of the pin contacting the pulley. In sum, the distribution of stress on the link plate becomes uneven.

An uneven stress distribution such as described above must be avoided because of its negative impact on the durability of the link plate and, by extension, the belt. U.S. Pat. No. 5,728,021 gives no consideration to uneven stress caused by different pins.

### SUMMARY OF THE INVENTION

In view of the foregoing problem, the main object of the present invention is to make the distribution of stress on the link plate uniform and thereby improve the durability of the endless belt.

In order to achieve the foregoing object, the present invention provides an endless belt that includes a link plate, and a pair of joint pins with different sectional areas that are fitted into a hole formed in the link plate and retained at peripheral faces contacting the link plate. The pair of joint pins have respective opposing areas on their peripheral faces that are rolling faces, and are respectively adjacent joint pins retained by a different and adjacent link plate. The joint pins rotatably connect the link plates so as to form as endless belt. Furthermore, the peripheral width of the link plate perpendicular to the running direction of the belt on the side that retains the joint pin with a small sectional area is formed larger than the peripheral width perpendicular to the belt running direction on the side that retains the joint pin with a large sectional area.

Additionally, the present invention further provides an endless transmission belt that includes a link plate, and a pair of joint pins with different lengths that are fitted into a hole formed in the link plate and retained at opposing peripheral faces of the link plate. The pair of joint pins have respective contacting faces that are rolling faces, and are respectively adjacent joint pins retained by a different and adjacent link plates, such that rotation of the mutually contacting (rolling) faces of joint pins rotatably connect the link plates so as to form an endless chain. Furthermore, the long joint pin has engagement faces on both ends thereof that engage a pulley, whereas the short joint pin is formed shorter than the long joint pin so as not to contact the pulley. Moreover, the peripheral width of the link plate perpendicular to the belt running direction on the side that retains the short joint pin is formed larger than a peripheral width perpendicular to the belt running direction on the side that retains the long joint pin.

In the foregoing structure, the peripheral width of the link plate on at least the inner peripheral side of the endless belt is formed larger than the peripheral width on the side retaining the long joint pin.

According to the present invention, the peripheral width of the link plate in a direction perpendicular to the belt running direction on the side retaining the joint pin with a small sectional area (short joint pin) is larger than the peripheral width in a direction perpendicular to the belt running direction on the side retaining the joint pin with a larger sectional area (long joint pin). Therefore, the strength can be increased by increasing the sectional area of that portion where there is considerable stress, with respect to a pulling force acting lengthwise of the link plate with a constant thickness. Consequently, it is possible to make the stress acting on each portion uniform for the entire link plate.

### BRIEF DESCRIPTION OF THE DRAWINGS

FIG. 1 is a side view of a link plate and joint pins of an endless transmission belt according to a first embodiment of the present invention;

FIG. 2 is a partial plan view showing a connection of belt links;

FIG. 3 is a sectional view of a portion of the belt in contact with a pulley;

FIG. 4 is a side view showing a link plate and joint pins of an endless transmission belt according to a second embodiment; and

FIG. 5 is a partial side view showing the connecting structure of an endless transmission belt of the related art.

### DETAILED DESCRIPTION OF THE PREFERRED EMBODIMENTS

In the present invention it is preferred that a joint pin with a large sectional area have both ends engage a pulley, and serve as a long pin that transmits driving force from the pulley to a link plate. On the other hand, a pin with a smaller sectional area is preferably the pin of the pair not engaged with the pulley, and is a shorter pin that transmits driving force between the joint pins and the link plate. In such a structure, the high-strength pin with a large sectional area can be used as a pin bearing a large load, whereas the low-strength pin with a small cross-sectional area can be used as a pin that bears a smaller load. Moreover, the pitch interval can be narrowed through the use of pin that has a small sectional area and does not contribute to the transmission of driving force to/from the pulley, thus making it possible to reduce belt vibration caused by the polygonal effect and the resultant noise.

### First Embodiment

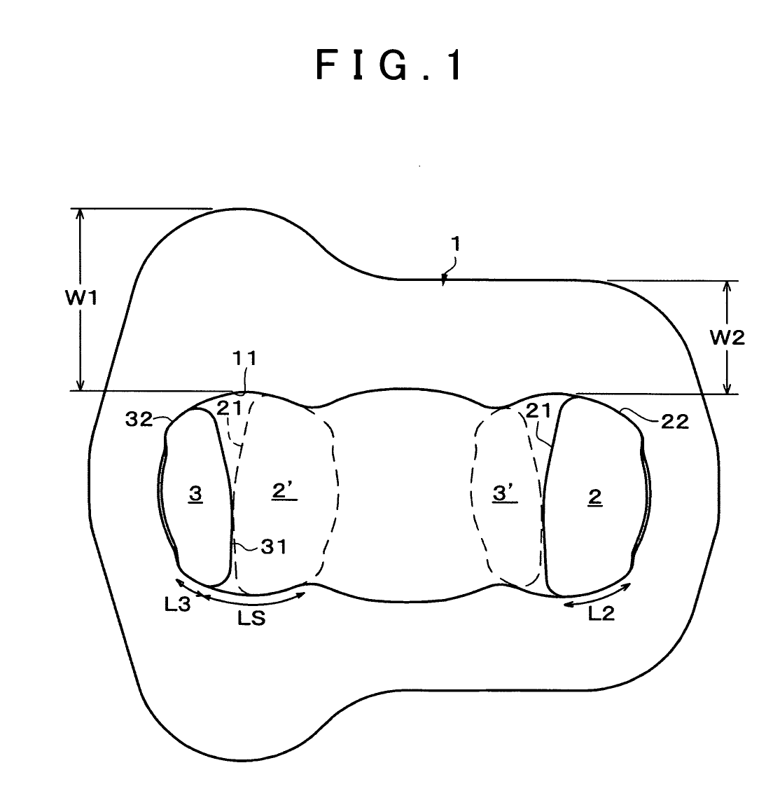

FIGS. 1 to 3 show an endless transmission belt according to a first embodiment. FIG. 1 shows a link plate 1 with joint pins 2, 3 retained therein. As shown in the figure, the joint pins 2, 3 have different sectional areas. The joint pins 2, 3 are fitted into a hole 11 formed in the link plate, and are retained by peripheral faces 22, 32 abutting the link plate 1. The pair of joint pins 2, 3 respectively include rolling peripheral faces 21, 31 located adjacent joint pins 3′, 2′ that are respectively retained by a different adjacent link plate 1′. The link plates are mutually and rotatably connected into an endless chain, owing to the rolling contact of the adjacent rolling faces of the joint pins 2, 3′ and of the joint pins 3, 2′.

The “pair of joint pins” referred to in the present specification are pins that are separated, at opposing ends of and retained by one link plate, e.g., the two joint pins 2, 3 shown by solid lines in FIG. 1.

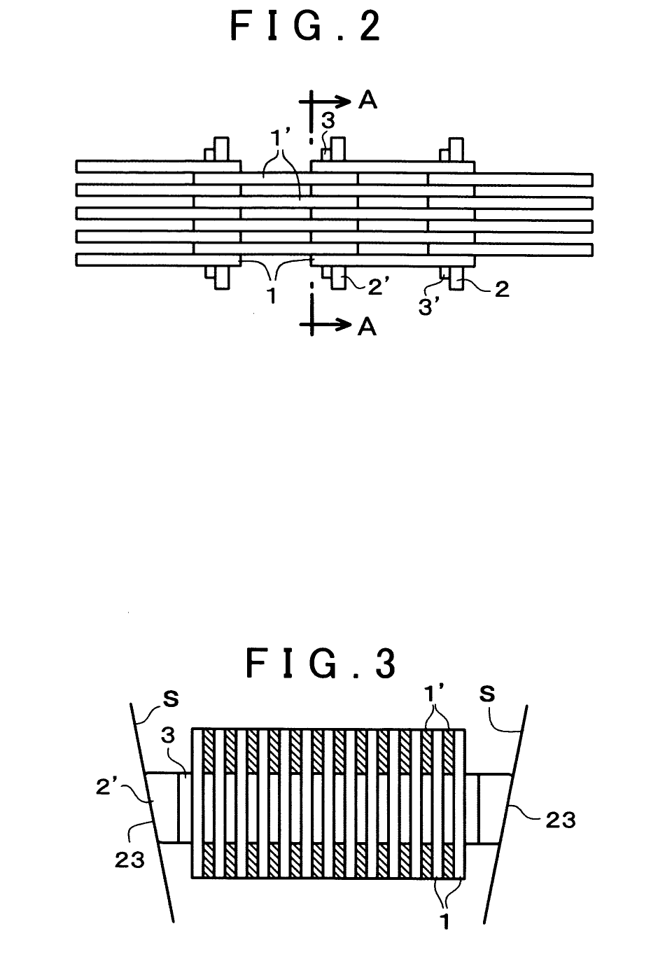

FIG. 2 shows a partial straight run of the belt as viewed from its periphery. As shown in the figure, the two pins (the pin 3 shown by a solid line and the pin 2′ shown by a broken line in FIG. 1) that form a set joining adjacent link plates 1, 1′ have a physical relationship different from that of the joint pins 2, 3. The link plate 1′ shown in FIG. 2 overlaps the link plate 1 shown in FIG. 1 at the position of the pin 2′ shown by the broken line and the position of the pin 2 shown by the solid line, while maintaining all previously described relative physical relationships with the retained pins. Such a physical relationship of the adjacent link plates 1, 1′ in the thickness direction is continued in sequence across the belt width and around the periphery to form the endless belt.

FIG. 3 shows a belt cross section (cross section A-A in FIG. 2) in a state in contact with (wrapped around) a pulley S. As shown in the figure, the pin 2 of the pair of joint pins is a driving pin with a larger sectional area that transmits driving force between the pulley S and the link plate 1, and has engaging faces 23 at opposing ends thereof which engage the pulley S. In order to engage with the pulley S, the pin 2 (hereafter referred to as a “long pin”) is longer than the pin 3. The pin 3 of the pair of joint pins is a force transmitting pin with a smaller sectional area that transmits driving force from the long pin 2 to the link plate 1. This pin (hereinafter similarly referred to as a “short pin”) is shorter than the long pin so as to avoid engagement with the pulley S.

As shown in FIG. 1, the short pin 3 of the pair of joint pins, with a small sectional area, is thinner in the belt running direction, thus making it possible to shorten the pitch interval (distance) between long pins 2 with a larger sectional area. Thus, the long pin 2 with a large sectional area is necessarily a pin whose thickness in the belt running direction is thicker, whereas the short pin 3 with a small sectional area is a pin whose thickness in the belt running direction is thinner by necessity. Such factors provide a retained peripheral length L3 for the short pin 3 with respect to the link plate 1 shorter than a retained peripheral length L2 for the long pin 2 with respect to the link plate 1.

As shown in FIG. 1, the link plate 1 is formed with a peripheral width W1 larger than a peripheral width W2. The peripheral width W1 is a dimension extending in a direction (vertical direction in FIG. 1) perpendicular to the belt running direction, at the end of the link plate 1 where the joint pin 3 with a small sectional area is retained, while the peripheral width W2 is a dimension extending in a direction perpendicular to the belt running direction at the end of the link plate 1 where the joint pin 2 with a large sectional area is retained. Thus, as used herein, “peripheral width” of the link plate is a dimension in the plane shown in FIG. 1 between an outer periphery of the link plate and an inner periphery of the link plate formed by an engagement hole 11. Note that the exterior shape of the link plate shown in FIG. 1 is a simplification of the actual shape, simplified for the purpose of emphasizing the difference in peripheral widths, and that the difference in peripheral widths has been exaggerated. However, in reality, the face on the inner side in the direction of the link plate width, for example, is determined by taking into account such matters as the setting of the outer shape so as to avoid interference between the pulley shaft and the inner peripheral face of the belt when in contact with the pulley.

Referring to FIG. 1, when the long pin 2′ shown by the broken line is in contact with the driving (primary) pulley in the endless belt formed as described above, driving force from the pulley is transmitted to the long pin 2′. Such driving force acts as a force in a direction (a force to the left in the figure) compressing the short pin 3 against the long pin 2′ and is transmitted to the link plate 1 via the short pin 3. Conversely, the force which acts on the link plate 1 as a load from the driven (secondary) pulley pulls the belt in the direction of tension. Such a pulling force ultimately acts on the long pin 2 (solid line) in a direction (to the right in the figure) opposite the belt running direction, via the short pin 3′ (broken line). According to this force relationship, tensile force acts on the link plate 1 in the direction of its length (the belt running direction).

The stress caused by such tensile force on the link plate 1 is equivalent on the retained sides of all pins, provided that the link plate has a constant thickness and that the areas of the retained portions of the long pin 2 and the short pin 3 with respect to the link plate are the same. However, according to the above-described relationship, a pair of joint pins is given a generally circular cross section, with one pin having a large sectional area and the other having a small sectional area. Consequently, the contact area between the short pin 3 and the peripheral face of the engagement hole 11 is smaller, resulting in a shorter retained peripheral length L3. Therefore, considerable stress is generated on a portion LS (which is an area that does not necessarily indicate the exact area of stress concentration), rearward from the retained portion of the short pin 3, due to the large load per unit area.

Hence, according to this embodiment, in order to increase the sectional area of the link plate 1, which has a constant thickness, at the portion LS where stress concentrates as described above, the plate peripheral width W1 is increased. In this embodiment, the width is increased on both sides of the hole 11, i.e., on the belt inner peripheral side and on the belt outer peripheral side, assuming that the stress concentration is uniform across the width of the link plate.

Such an increase in width also increases the sectional area of the link plate 1 at that portion, and therefore reduces the stress per unit area and balances the stress with respect to the other portions.

Also note that other modifications could lower the stress caused by tension on the link plate in the direction of its length (belt running direction). For example, the radius of a curvature of a peripheral face retaining the short pin on the inner periphery of the link plate could be increased. However, an increase in the radius of curvature results in a larger link plate overall, which is undesirable due to the accompanying increase in weight. Furthermore, increasing the radius of curvature of the peripheral shape of the short pin leads to an increase in the sectional area of the short pin. The pitch distance is thus increased as a result and consequently gives rise to louder noise.

A reduction in stress can also be achieved by changing the thickness of each link plate on the side requiring greater strength. However, considering that a plurality of link plates must be arranged in parallel across the width of the belt, it is preferable that the thickness of each link plate be uniform. In fact, the thickness of the link plates is preferably as thin as possible. This is because thinner link plates reduce the width of the belt overall and make it possible to narrow the distance between two pulley sheaves facing each other. Therefore, the entire transmission can be made more compact. Furthermore, a narrow belt width also lightens the weight of the belt, which is advantageous for torque transmission efficiency and suppressing noise caused by contact between the belt and pulley.

Based on the foregoing circumstances, making the stress more uniform by increasing the peripheral width of the link plate as in the present invention is thus a more effective approach. Especially in the first embodiment, a strong pulling force acts lengthwise on the link plate, and the pulling force is borne by a particular region on the periphery of the engagement hole in the link plate. Thus, spreading the stress at this peripheral region is desirable in order to make the stress on the link plate more uniform overall. To that end, it is most preferable that the width W1 on the side retaining the short pin 3 be made larger than the width W2 on the side retaining the long pin 2, for the sake of making the stress uniform and minimizing the overall size of the link plate.

### Second Embodiment

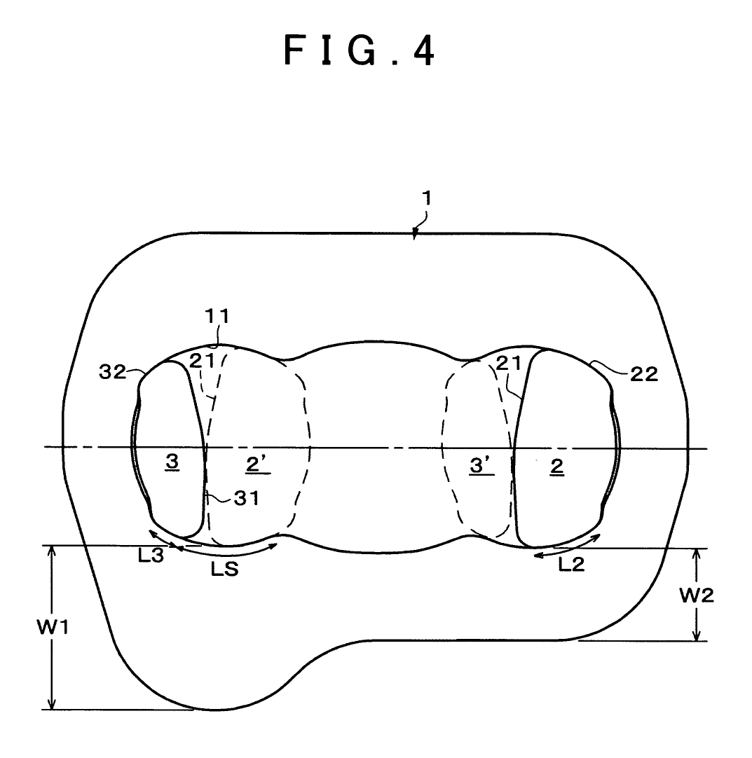

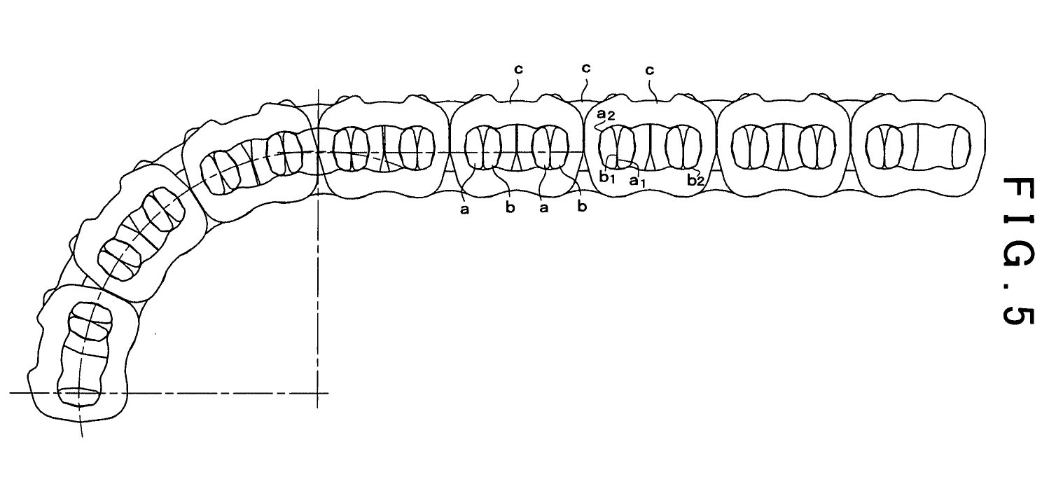

A second embodiment is shown in FIG. 4 and differs from the first embodiment in that the peripheral width of the link plate is increased only on the belt inner peripheral side. All other features are identical to those of the first embodiment and, therefore, corresponding structure is denoted by the same reference numerals, and repeat of description of such structure shall be omitted. Hereinafter, only those features that differ from the first embodiment will be described.

As shown in FIG. 4, according to this embodiment the position of contact between the short pin 3 with a small sectional area and the long pin 2′ with a large sectional area of an adjacent link plate (the position where a contact force is transmitted between pins) is on a substantially lower (lower relative to than a link center line, i.e., the belt inner peripheral side, as shown by a dashed line in the figure) side of the link plate 1. The embodiment assumes that such a contact position crosses the center line and moves somewhat to the upper side when contacting the pulley. Furthermore, the position at which the contact force is transmitted is determined by the pin shape.

The stress acting on the link plate 1 is naturally greater on the lower side of the link plate. Therefore, only the lower part of the link plate 1, that is, the peripheral width W1 on the side retaining the short pin 3 need be made larger than the peripheral width W2 on the side retaining the long pin 2. Thus, it is possible to reduce the stress on the lower side of the link plate, which is subjected to the greater (harsh) stress.

In this latter embodiment, stress acting on the link plate can be made uniform throughout the link plate by increasing the width of one side, on the assumption that the position of contact between the long pin and the short pin moves as described above. This in turn has the advantage of minimizing increase in belt weight due to need for reinforcement of the link plate.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An endless transmission belt comprising:
a first link plate having an outer periphery with an inner side and an outer side and a central hole defining an inner periphery; and
a pair of joint pins with different sectional areas retained at opposing ends of said central hole and having peripheral faces contacting the first link plate, and rolling faces contacting respective joint pins retained by a different and adjacent link plate, said joint pins rotatably connecting said link plates into the endless transmission belt; and wherein
a peripheral width of the first link plate perpendicular to belt running direction, extending from said inner periphery at one side of said hole to said inner side of said first link plate, at the end of said first link plate where the joint pin with a smaller sectional area is retained, is larger than a peripheral width perpendicular to the belt running direction extending from said inner periphery at said one side to said inner side of said first link plate, at the end of said first link plate where the joint pin with a larger sectional area is retained.

2. The endless transmission belt according to claim 1, wherein a peripheral width of said first link plate, extending from said inner periphery at a second side of said hole, opposite said first side, to said outer side of said first link plate, at the end of said first link plate where the joint pin with a smaller sectional area is retained, is also larger than a peripheral width perpendicular to the belt running direction and extending from said second side to said inner side of said first link plate at the end of said first link plate where the joint pin with a larger sectional area is retained.

3. An endless transmission belt comprising:
a first link plate having an outer periphery and a central hole defining an inner periphery; and
a pair of joint pins with different lengths retained at opposing ends of said central hole and having peripheral faces contacting the first link- plate and rolling faces contacting respective joint pins retained by a different and adjacent link plate, said joint pins rotatably connecting said link plates into the endless transmission belt; and wherein
the longer joint pin has engagement faces on opposing ends thereof that engage a pulley, whereas the shorter joint pin is formed shorter than the longer joint pin so as not to contact the pulley, and wherein
a peripheral width of the first link plate perpendicular to belt running direction, extending from said inner periphery at one side of said hole to said inner side of said first link plate, at the end of said first link plate where the shorter joint pin is retained, is larger than a peripheral width perpendicular to the belt running direction extending from said inner periphery at said one side to said inner side of said first link plate, at the end of said first link plate where the longer joint pin is retained.

4. The endless transmission belt according to claim 3, wherein a peripheral width of the first link plate extending from said inner periphery at a second side of said hole, opposite said first side, to said outer side of said first link plate, at the end of said first link plate where the shorter joint pin is retained, is also larger than a peripheral width perpendicular to the belt running direction and extending from said second side to said outer side of said first link plate where the longer joint pin is retained.
